(19) United States
(12) Patent Application Publication
(10) Pub. No.: US 2025/0353256 A1
(43) Pub. Date: Nov. 20, 2025

(54) ASCERTAINING A TEMPERATURE CURVE OF A LAYER

(71) Applicant: Siemens Aktiengesellschaft, 80333 München (DE)

(72) Inventors: Frank Heinrichsdorff, Teltow (DE); DARYA KASTSIAN, Falkensee (DE); DANIEL REZNIK, Berlin (DE)

(73) Assignee: Siemens Aktiengesellschaft, 80333 München (DE)

(21) Appl. No.: 18/861,089

(22) PCT Filed: Feb. 20, 2023
(86) PCT No.: PCT/EP2023/054202

§ 371 Date: Oct. 28, 2024

(30) Foreign Application Priority Data
Apr. 29, 2022 (EP) 22170872.0

(51) Int. Cl. B29C 64/386; B29C 64/153; B33Y 10/00; B33Y 50/00

(52) U.S. Cl. CPC B29C 64/386; B29C 64/153; B33Y 10/00; B33Y 50/00

(57) ABSTRACT

In a computer-implemented method for ascertaining a temperature curve of a layer, which is a cross-section of an object, for selective solidification of the layer by a laser or electron beam for a powder-based additive manufacturing process, exposure vectors are provided for the layer. A model of the layer is provided, wherein the model represents the layer and a portion of the object lying below the layer as the cross-section of the object, and takes into account a portion of the object lying below the layer as a location-dependent specific heat capacity and a location-dependent thermal resistance. The temperature curve is ascertained by thermally simulating a scan of the layer with the exposure vectors using the model.

The invention relates to a method for ascertaining a temperature curve of a layer using a model, a method for ascertaining a parameter function for the model, a method for validating exposure vectors and a method for producing a layer of an object.

Such methods are used, for example, in powder-based additive manufacturing processes with laser or electron beams.

The invention is based on the object of improving the thermal simulation of individual layers before or during production.

This object is achieved by a method with the features disclosed in claim 1.

In order to ascertain a temperature curve of a layer, which is a cross-section of an object, for selective solidification of the layer by means of a laser or electron beam for a powder-based additive manufacturing process, the method comprises the following steps:
providing exposure vectors for the layer,
providing a model of the layer and
ascertaining the temperature curve by thermally simulating a scan of the layer with the exposure vectors using the model.

The model represents the layer and a portion of the object below the layer in the form _{Q}f a cross-section. The cross-section has the shape of the layer and takes into account a portion of the object lying below the layer in the form of a location-dependent specific heat capacity and a location-dependent thermal resistance. This makes it possible to represent the complexity of the thermal simulation of a 3D model in a simplified model, wherein the model has no Z-dependency and the three-dimensionality in two dimensions is taken into account by location-dependent specific heat capacities and location-dependent thermal resistances. This has the great advantage that it is not necessary to calculate in three dimensions, but can be calculated in two dimensions. The layer can be modeled as a solid, i.e. the powder form can be neglected. The temperature of the portion below the layer can be approximated as a building board temperature or calculated quasi-statically to ascertain an ambient temperature.

It is assumed that the model is created with the material parameters of the object to be built, i.e. for a material from which the object is also built.

The exposure vectors contain information about the power of the beam, the beam width and at what speed at which location of the layer the beam is travelling. This can be done either via a speed with a start and end point or a location coordinate with a time coordinate. Vector data sets of the layer can therefore contain all exposure vectors that are used to scan a layer and thus completely describe a power input into the layer. Such exposure vectors can be used as input parameters for standard 3D printing systems as machine parameters. The technical information of the object is preferably provided in a 3D CAD model of the object. The 3D CAD model contains, among other things, the material of the object, the density of the object, the physical dimensions of the object and the layers of the object. Such 3D CAD models are usually created during the construction of an object. Due to the location dependency of the heat capacity and the thermal resistance, a high level of accuracy can also be achieved in the two-dimensional case, as with simulations in the three-dimensional case, with considerable savings in computing time. This makes it possible to use the method immediately before production or even during production, for example for the exposure of subsequent layers.

In a further embodiment, the location-dependent thermal resistance is determined as a first parameter function as a function of a local depth and/or the location-dependent specific heat capacity is determined as a second parameter function as a function of a local depth. The properties of the three-dimensional problem can be mapped to the two-dimensional model in an improved manner due to the dependency of the local depth. The local depth can be considered as the Z-extent of the object below the layer in each case perpendicularly below the considered point. It is also possible to consider volumes, for example ellipsoids, which represent effective volumes below the point. For this purpose, an integral could be performed over a hemisphere and/or over a cylinder below the layer around a point under consideration. The corresponding limiting case is, as described at the beginning, the actual local depth. The local depth can be extracted from the 3D CAD model. Depending on the design of the object, it may be advantageous to use the perpendicular extent or the volume extent below the object. If a volume is used, jumps in the local depth can be avoided for rectangular structures in the object, which can help the calculation (and the differentiation of the function). The location-dependent thermal resistance (RTH) is taken into account by a first parameter function (fl) and the location-dependent heat capacity (CTH) by a second parameter function (fd). The resistance and the capacitance could also be described as a location-dependent coating.

In a further embodiment, the model takes into account a heat loss in the portion below the layer by way of a first source term in a time-dependent and location-dependent heat conduction equation. The source term, which is negative in particular, can be used to eliminate the Z-dependency in the model and thus perform a two-dimensional calculation. It can be assumed that the heat loss is expressed by diffusion, i.e. heat conduction.

In a further embodiment, the first source term takes into account a location-dependent coating of the thermal resistance by way of a first parameter function. In addition or as an alternative, the source term takes into account a location-dependent coating of the thermal capacity by way of a second parameter function. The use of parameter functions enables a sufficiently accurate mapping of the thermal resistance and the heat capacity from the three-dimensional case to the layer or the model of the layer. Surface-related summarized thermal properties are referred to as thermal coatings.

In a further embodiment, the first parameter function is a real part and the second parameter function is an imaginary part of a location-dependent complex-valued thermal impedance coating for the location-dependent definition of the specific heat capacity and the location-dependent definition of the thermal resistance. It has proven to be particularly advantageous to use such a complex-valued impedance coating for the thermal properties, since this offers greater accuracy with simpler calculability when comparing the 2D model with the 3D model. The first parameter function represents the thermal resistance as the real part and the second parameter function represents the specific heat capacity as the imaginary part of the location-dependent complex-valued thermal impedance coating.

In a further embodiment, the model takes into account heat coupling by the laser or electron beam into the layer by way of a second source term in a time-dependent and location-dependent heat conduction equation. The heat coupling is calculated on the basis of the exposure vectors. The first and second source terms can therefore be used to describe the heat coupling and the heat dissipation through the portion under the layer.

In a further embodiment, the location-dependent specific heat capacity and/or the location-dependent thermal resistance are each defined as discrete values at definable node points and/or as continuous functions over the cross-section. It is possible to define a function for continuous structures that are largely unchanging over the depth profile. In the case of very complex structures, it is possible to specify values at definable node points section by section using an appropriate discretization. The simulation method used can also have an influence here. A continuous function can be used for a finite element method and a discrete representation for a finite volume or finite difference method.

The object is also achieved by a method for ascertaining a parameter function for a model. The parameter function is dependent on a local depth and is suitable for a method according to the invention for ascertaining a temperature curve. As described at the beginning, the model has the form of a cross-section of an object, wherein the cross-section represents a layer and takes into account the portions of the object lying below the layer in the form of a location-dependent specific heat capacity and a location-dependent thermal resistance. In this case, the method comprises the following steps.

Ascertaining a first temperature curve by thermal simulation of a test body when irradiated by exposure vectors which are so far away from the limits of the test body that the test body behaves like an infinite half-space with respect to the temperature curve. In other words, the exposure vectors are arranged on an appropriately dimensioned body in such a way that the heating generated by the exposure vectors on the irradiated surface does not reach the remaining limits of the body, but instead generates heating in the body, although this heating does not reach the limits.

In a further step, start parameters for the model are determined from this first temperature curve. This means that a first start parameter for the thermal resistance and a second start parameter for the specific heat capacity are determined for a large body. Since the test body in this case behaves like an infinite half-space, the parameter functions converge towards the values of the start parameters.

In one step, at least a second temperature curve is ascertained by thermal simulation of a second test body. The exposure vectors are arranged on the second test body in such a way that the test body has the properties of a limited space with regard to the temperature curve. In other words, the local-depth below the exposure vectors is limited in such a way that heating takes place up to the limits of the body. This allows the behavior of the model to be modeled for limited bodies.

In a further step, a parameter function for the specific heat capacity and the thermal resistance is determined so that a temperature curve ascertained using the model adapts to the first and second temperature curves of the test bodies. In particular, a parameter function is determined in each case on the basis of the start parameters, which, in addition to the infinite limit case, also models limited bodies by way of a dependency on the local depth.

In a further embodiment, the parameter functions converge towards the start parameters from a sufficiently large local depth. The temperature distribution there behaves as in an infinitely large half-space, so the start parameters can be used here accordingly.

In a further embodiment, the second parameter function converges towards a smaller value than the second start parameter if the local depth is very small. This can be the case directly at the start of the manufacturing process, for example, if there are still a few layers below the current layer.

The first parameter function converges towards a larger value than the first start parameter. The first parameter function models the location-dependent thermal resistance and the second parameter function models the location-dependent heat capacity.

In a further embodiment, the parameter functions are monotonic. Continuous differentiability of the parameter functions is not required.

In general, the following has proven to be advantageous for the parameter functions:
For sufficiently large values of the local depth, the functions should converge towards the starting values.
For a local depth that approaches 0, the first parameter function (fₗ, thermal resistance) should converge towards a large value (no/hardly any effective downward heat dissipation).
For a local depth that approaches 0, the second parameter function (f_{d}, representing specific heat capacity) should move towards a small value (small thickness).
It can be assumed that the parameter functions are monotonic.
A practicable approach is a decreasing exponential function for the first parameter function (fₗ, thermal resistance, RTH) and
a piecewise linear function for the second parameter function (f_{d}, representing a specific heat capacity, CTH).

The first parameter function represents the thermal resistance as a real part and the second parameter function represents the specific heat capacity as an imaginary part of the location-dependent complex-valued thermal impedance coating.

The object is further achieved by a method for validating exposure vectors. Validation should be understood here to mean that the exposure vectors do not produce overheating or excessively high temperatures of the layer over too long a period of time. In other words, the validated exposure vectors can be used to solidify a layer without any problems without temperature-related problems occurring. In order to validate the exposure vectors for selectively solidifying a layer of an object using a laser or electron beam for a powder-based additive manufacturing process, the following steps are proposed:
providing exposure vectors for the layer,
ascertaining a temperature curve of the layer by means of the method according to the invention, which was described at the beginning, and
validating the temperature curve using one or more criteria.

In a further embodiment, a duration of the temperature above a limit temperature is used as a criterion. If the temperature remains above the limit temperature for too long, the quality of the layer deteriorates considerably and can even lead to the manufacturing process having to be cancelled.

In another embodiment, an absolute maximum temperature is used as a criterion. If the temperature curve exceeds an absolute maximum temperature, for example a vaporization temperature of the material, the exposure vectors used are unsuitable and must be discarded.

In a further embodiment, a maximum area above a temperature is used as a criterion. Since the temperature curve is ascertained two-dimensionally, surfaces can also be considered. Of particular interest is the maximum size of a melt pool, i.e. an area that has a temperature above the melting temperature of the material used. If the maximum surface area of the melt pool is exceeded, this can lead to uneven solidification molds, which also has a negative effect on the quality of the object.

Therefore, the criteria mentioned should be undercut. Further optimization criteria can be a total duration of the exposure vectors, i.e. how long it takes to scan the selected exposure vector pattern in order to expose the entire layer. Conventional optimization methods can be used when comparing several exposure vectors or exposure vector sets with each other.

The object is also achieved by a method for selectively solidifying a layer. The layer is part of an object that is to be manufactured by means of a laser or electron beam using a powder-based additive manufacturing process. The method comprises the steps of providing exposure vectors that have been validated by means of a method for validating the exposure vectors and scanning the layer by the energy beam with the exposure vectors.

In general and in other words, the local thermal impedance acts as a representative of the third dimension and can be defined either as a cloud of discrete values (thermal impedances are defined only at node points) or as a continuous (over a spatially variable impedance coating) function of location.

The values used for the node impedances or the impedance coating function are adapted to the geometric distribution of the material below the simulated plane. In the case of a large body in relation to the exposure vectors, the mass distribution below the considered plane is the same and the impedance coating function would be spatially constant.

If the mass distribution (geometry) is uneven, the values of the impedance coating function must be adjusted locally in a suitable section, for example below wedge-shaped overhangs (the resistive component should increase, the capacitive component should decrease).

A heat conduction equation without Z-dependency, but which takes into account the portion below the layer, can be designed as follows:

$$ρ {c}_{p} \frac{\partial T}{\partial t} + ∇ \cdot {J}_{th} = {Q}_{N} ( x , y ) + {Q}_{L} ( x , y , t ) \qquad ( 1 )$$

$${Q}_{N} = - \frac{κ}{{f}_{l} ( {l}_{t} ) \cdot {f}_{d} ( {l}_{t} )} \cdot ( T - {T}_{ref} ) \qquad ( 2 )$$

$${J}_{th} = - κ ∇ T \qquad ( 3 )$$

T_{ref} Reference temperature
h[W/(m²K)] Heat transfer coefficient
ρ Density
Cₚ Heat capacity
κ Thermal conductivity
Jₜₕ Heat flux density
Q_{L} Source term of the laser or electron beam, can be considered as a Gaussian radiation source, for example
Q_{N} Source term, which represents a heat loss into the portion of the object below the layer
fₗ first parameter function; represents a thermal resistance, can be defined as a characteristic length and is a thermal resistance coating
f_{d} second parameter function; represents a specific heat capacity, can be defined as a characteristic thickness and is thus a thermal capacitance coating

In the following, the invention is described and explained in more detail with reference to the exemplary embodiments shown in the figures. In the drawing:

FIG. 1 shows schematically an object,

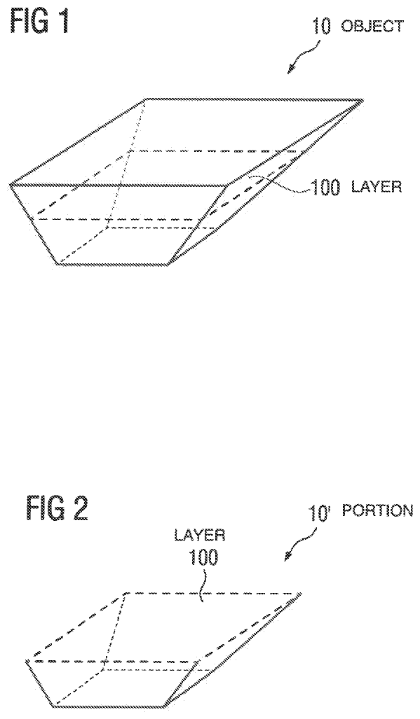

FIG. 2 shows schematically a portion of the object,

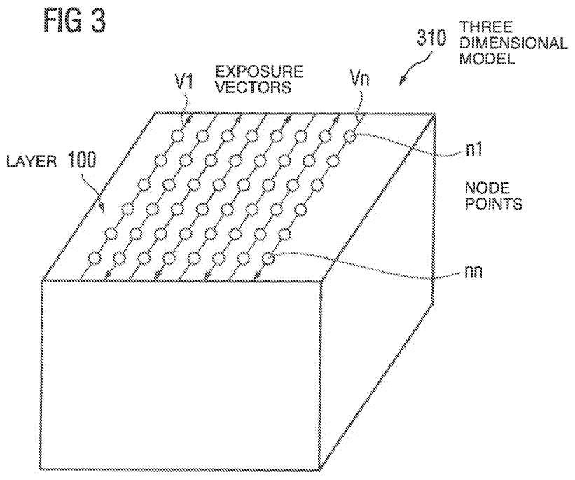

FIG. 3 shows schematically a 3D model of a cuboid,

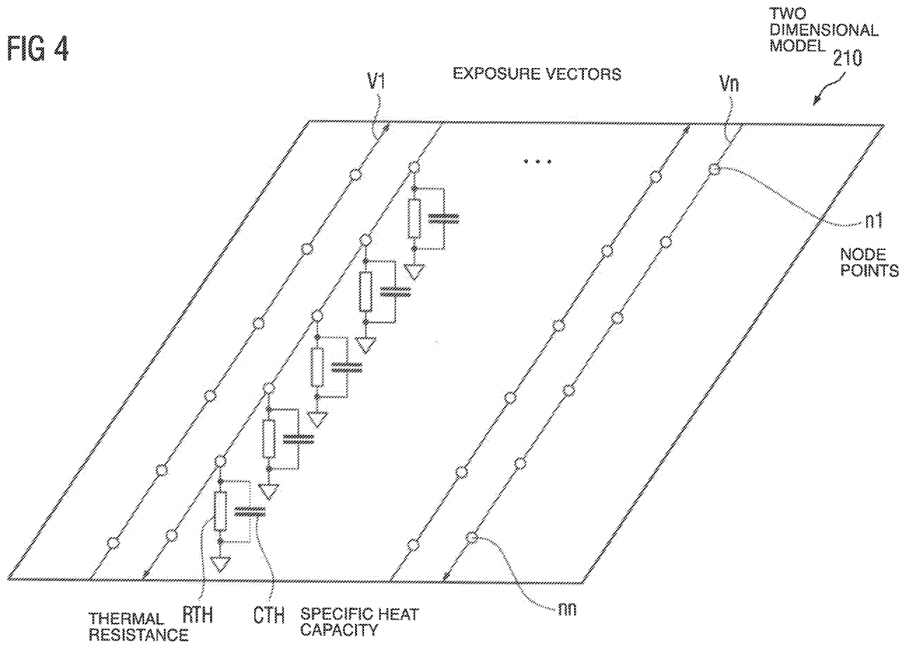

FIG. 4 shows schematically a 2D model of a layer,

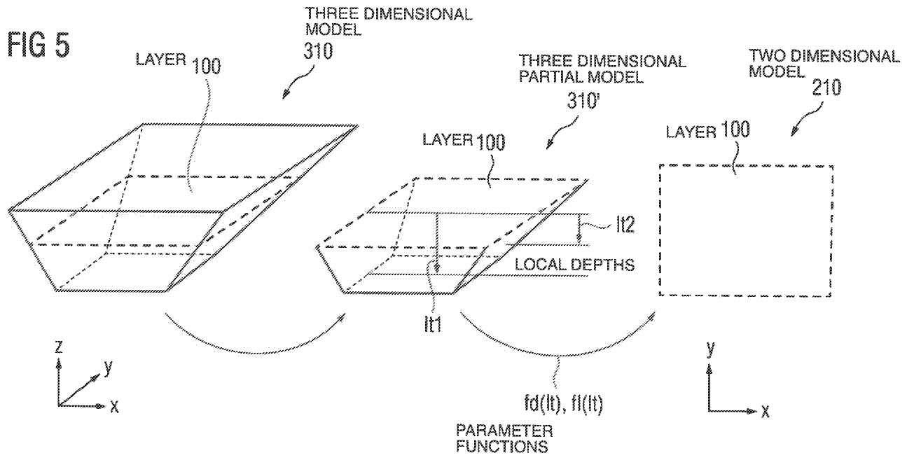

FIG. 5 shows the modeling process in detail,

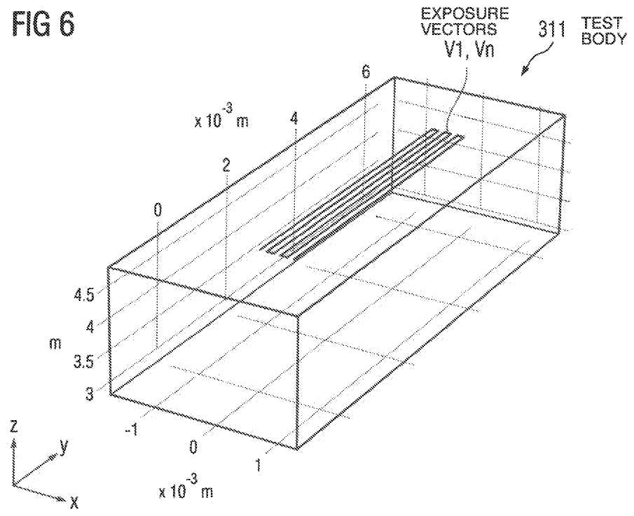

FIG. 6 shows a test body for determining initial parameters,

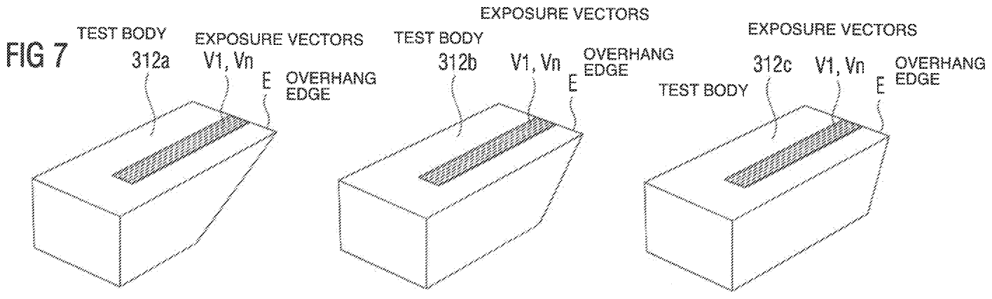

FIG. 7 shows a test body for parameterization,

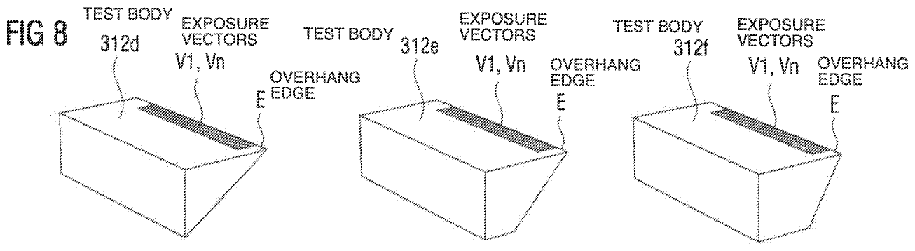

FIG. 8 shows a test body for parameterization,

FIG. 9 shows a temperature curve,

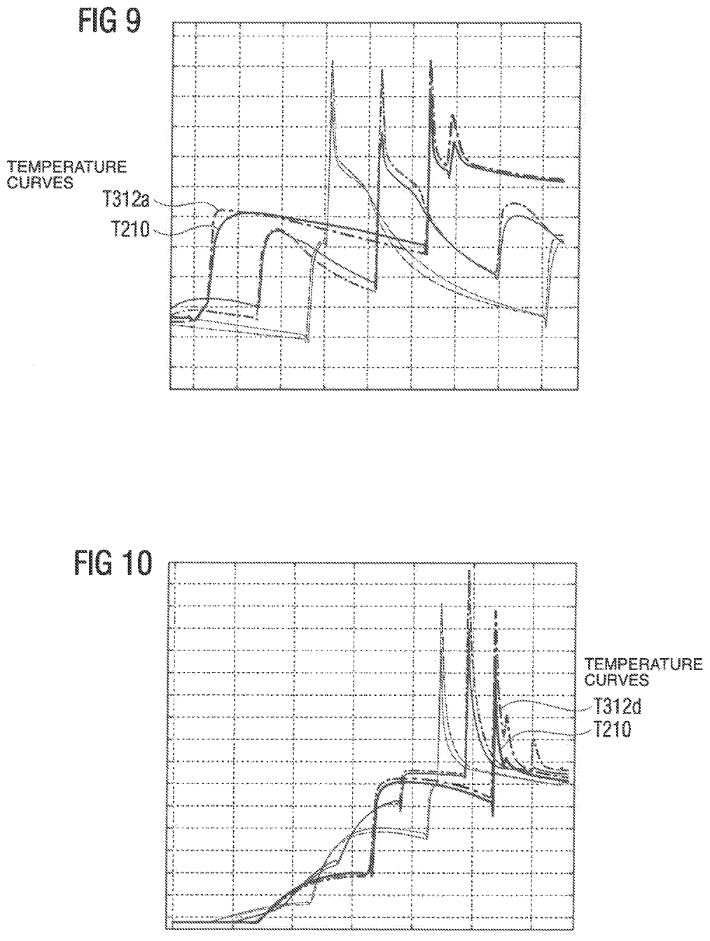

FIG. 10 shows a further temperature curve, and

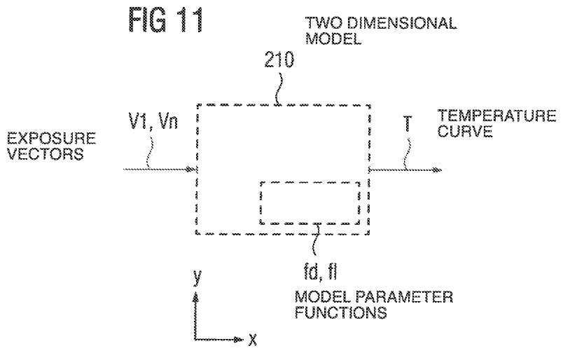

FIG. 11 shows a simplified model.

FIG. 1 shows an object 10 which represents a non-inverted truncated pyramid whose angles are not evenly distributed. A layer 100 is also shown and represents a cross-section of the object 10 in the plane of the layer 100.

FIG. 2 shows the object 10, wherein it was only manufactured up to the layer 100, i.e. for example during the manufacturing process, wherein a portion 10′ located below the layer is labeled. The portion 10′ is decisive for the thermal properties of the layer 100.

FIG. 3 shows a three-dimensional model 310 of a cuboid. Exposure vectors V1, Vn are drawn on the model 310 of the cuboid. The eight exposure vectors V1, Vn are always arranged alternately and parallel to each other in terms of direction. The exposure vectors V1, Vn are discretized and have node points n1, . . . , nn. The model 310 has thermal properties at each of the node points n1, nn. These are now to be transferred to a 2D model.

FIG. 4 shows a two-dimensional model 210 of the uppermost layer 100, wherein each of the nodes n1, nn, shown here only for one of the vectors V1, Vn, is assigned a thermal resistance RTH and a specific heat capacity CTH. These thermal parameters, which can also be referred to as an impedance coating, map the model 310 to the two-dimensional model 210. Thus, it is a two-dimensional representation of the model 310, where the Z-axis is considered by the thermal properties RTH, CTH.

FIG. 5 shows the modeling process in detail. The 3D model 310, in which the layer 100 is located, is shown. A coordinate system with the coordinates x, y, z is shown, wherein the layer 100 is located in a plane defined by the X and Y axes. The object 310 is constructed in the Z direction. In the modeling process, the dependency on the Z direction is now to be eliminated.

A three-dimensional partial model 310′, which is only constructed up to layer 100, has different local depths It1, It2. The modeling of the model 210 should take into account these different local depths It1, It2 and their influence on the respective local thermal properties. Since additively manufactured objects can generally have significantly more complex geometries and correspondingly different local depths, these must be taken into account in the two-dimensional case. This is taken into account by a first parameter function fl(It) as a function of the local depth it and a second parameter function fd(It) also as a function of the local depth. The first parameter function fl represents the thermal resistance RTH and the second parameter function fd represents the specific heat capacity CTH. Thus, in the final step, a model 210 can be created that is two-dimensional and also represents the layer 100 in two dimensions. The first parameter function fl and the second parameter function fd are used.

FIG. 6 shows a body for a first step for parameterizing the parameter functions fd, fl, or for determining the start parameters occurring in the limit case. For this purpose, a test body 311 is shown which has a large extent in relation to the exposure vectors V1, Vn shown. In a simple form, the test body 311 can be a cuboid on whose surface the exposure vectors V1, Vn are arranged. These can be arranged in the center of a surface of the cuboid in such a way that the thermal effects of the exposure vectors never reach the edges. As we are dealing here with uniform, namely very large or relatively infinitely large, local depths it, it is possible from a calculation point of view to use a simple and correspondingly large body. A thermal simulation of the vectors V1, Vn drawn on the test body provides a temperature curve from which the start parameters can then be determined.

FIG. 7 shows three further test bodies 312a, 312b, 312c, wherein the exposure vectors are arranged perpendicular to an overhang edge E in each case. The test body 312a has an overhang angle of 30°, the test body 312b has an overhang angle of 45° and the test body 312c has an overhang angle of 60°. It has been shown that with these three angles or a combination of at least two of these overhang angles, the behavior of the temperature can also be mapped well for more general cases. The exposure vectors V1, Vn run in the direction of a decreasing local depth It or from the direction of an increasing local depth it, depending on the direction of the vector.

FIG. 8 shows three similar test bodies 312d, 312e and 312f, where the exposure vectors V1, Vn are arranged parallel to the overhang edge E. Here, from exposure vector to exposure vector, the strength or the local depth it becomes increasingly smaller or larger, which can lead to a considerable change in temperature and should therefore be included in the modeling.

FIG. 9 shows an actual temperature curve T312a as it would appear on three points on one of the exposure vectors V1, Vn. The points under consideration, each of which has its own graph, are located on an exposure vector that preferably already has a number of predecessor vectors, as this results in a certain temperature that is not yet set when one of the first exposure vectors V1, Vn is considered. A temperature curve T312a can be seen, which originates from the 3D calculation of the test body 312a and a temperature curve T210, which originates from the calculation of the two-dimensional model 210 after adjusting the parameters on the basis of the parameter functions, which are each dependent on the local depth. It can be seen that a very good agreement was achieved. All cases (all test bodies) can be used. Preferably, an angle (for example the center one at 45°) in the two versions perpendicular and parallel to the edge E is used first, and then it is checked whether the results for 60° and 30° correspond to the expectations and, if necessary, the parameters of the functions fl and fd are adjusted.

FIG. 10 shows a temperature curve T312d of the test body 312d analogue to FIG. 9, also viewed at three points on one of the vectors V1, Vn. Here too, a good agreement between the two-dimensional model and the results from the three-dimensional model was achieved.

FIG. 11 shows a simplified representation of the input variables of the model 210, namely any exposure vectors V1, Vn, which act on a two-dimensional model 210 representing a layer 100. In addition to the parameter functions fd, fl, the model 210 also has the corresponding material parameters. Density, heat capacity and thermal conductivity form the thermophysical properties and represent the material parameters that adequately describe a solid material with regard to the thermal simulation. The model described in this way enables fast and accurate simulation and validation of exposure vectors V1, Vn through to application during the manufacturing process. The model 210 can be stored in the memory of a simulation computer and executed in its processor. By reducing the model to a two-dimensional model with a dependency of the thermal properties on the local depth It, a considerable saving in computing time can be achieved and computers close to production can also carry out such a simulation. Accordingly, the model 210 can be calculated in an even shorter time on special simulation computers and can also be made available in production with cloud support, for example. The methods for ascertaining the parameter functions and the method for validating the exposure vectors can also be carried out on such computers. The method for ascertaining the parameter functions fd, fl only needs to be carried out once for a material used and can then be used for other objects. For this purpose, minor adjustments can be made to the parameter functions for certain objects, but it has been shown that the model 210 provides very good results.

In summary, the invention relates to a computer-Implemented method for ascertaining a temperature curve T of a layer 100, for selective solidification of the layer 100 by means of a laser or electron beam for a powder-based additive manufacturing process based on a model 210. The invention also relates to ascertaining a parameter function fd, fl which is dependent on a local depth It for a model 210 of the layer 100 for a method for ascertaining a temperature curve T, a method for validating exposure vectors V1, Vn and a method for selectively solidifying a layer 100 of an object 10.

### REFERENCE CHARACTERS

10 Object
10′ Proportion of the object below the layer
100 Layer
210 Model of the layer
310 Three-dimensional model of the object
311 First test body
312a, . . . , 312f Second test body
V1, Vn Exposure vectors
n1, nn Node points
T Temperature curve of the layer
CTH Location-dependent specific heat capacity
RTH Location-dependent thermal resistance
T312a, T312d Temperature curve of a test body
T210 Temperature curve of the layer, ascertained using the model
fl First parameter function fₗ
fd Second parameter function f_{d}
x,y,z Coordinate system

1.-17. (canceled)

18. A computer-implemented method for ascertaining a temperature curve of a layer, which is a cross-section of an object, for selective solidification of the layer by a laser or electron beam for a powder-based additive manufacturing process, the computer-implemented method comprising:
providing exposure vectors for the layer;
providing a model of the layer, wherein the model represents the layer and a portion of the object lying below the layer as the cross-section of the object, and takes into account a portion of the object lying below the layer as a location-dependent specific heat capacity and a location-dependent thermal resistance; and
ascertaining the temperature curve by thermally simulating a scan of the layer with the exposure vectors using the model.

19. The method of claim 17, further comprising:
determining the location-dependent thermal resistance as a first parameter function as a function of a local depth; and/or
determining the location-dependent specific heat capacity as a second parameter function as a function of the local depth.

20. The method of claim 17, wherein the model takes into account a heat loss into the portion lying below the layer by a first source term in a time-dependent and location-dependent heat conduction equation.

21. The method of claim 20, wherein the first source term takes into account a location-dependent coating of the thermal resistance by a first parameter function.

22. The method of claim 21, wherein the first source term takes into account a location-dependent coating of the heat capacity by a second parameter function.

23. The method of claim 22, wherein the first parameter function is a real part and the second parameter function is an imaginary part of a location-dependent complex-valued thermal impedance coating for the location-dependent specific heat capacity and the location-dependent thermal resistance.

24. The method of claim 18, wherein the model takes into account a heat coupling by the laser or electron beam into the layer based on the exposure vectors by a second source term in a time-dependent and location-dependent heat conduction equation.

25. The method of claim 18, wherein at least one of the location-dependent specific heat capacity and the location-dependent thermal resistance is defined as discrete values at definable node points and/or as a continuous function over the cross-section of the object.

26. A method for ascertaining a parameter function dependent on a local depth for a model of a layer, the method comprising:
providing a model of the layer, which is a cross-section of an object, wherein the model represents the layer and a portion of the object lying below the layer as the cross-section of the object, and takes into account a portion of the object lying below the layer as a location-dependent specific heat capacity and a location-dependent thermal resistance;
ascertaining a first temperature curve by thermal simulation of a test body when irradiated by exposure vectors which are so far away from limits of the test body that the test body behaves like an infinite half-space with respect to the first temperature curve;
determining start parameters for the model from the first temperature curve;
ascertaining a second temperature curve by thermal simulation of a second test body when irradiated by exposure vectors which are arranged at the limits of the test body in such a way that the test body has properties of a confined space with respect to the first temperature curve; and
ascertaining first and second parameter functions for the specific heat capacity and the thermal resistance, so that a temperature curve ascertained by the model adapts to the first and the second temperature curve of the test bodies.

27. The method of claim 26, wherein the first and second parameter functions converge towards the start parameters from a sufficiently large local depth.

28. The method of claim 26, wherein for a local depth converging towards 0, the second parameter function converges towards a smaller value than the second start parameter and the first parameter function converges to a greater value than the first start parameter.

29. The method of claim 26, wherein the first and second parameter functions are monotonic.

30. A method for validating exposure vectors for selectively solidifying a layer of an object by a laser or electron beam for a powder-based additive manufacturing process, the method comprising:
providing exposure vectors for the layer;
providing a model of the layer, wherein the model represents the layer and a portion of the object lying below the layer as a cross-section of the object, and takes into account a portion of the object lying below the layer as a location-dependent specific heat capacity and a location-dependent thermal resistance;
ascertaining a temperature curve by thermally simulating a scan of the layer with the exposure vectors using the model; and
validating the temperature curve based on one or more criteria.

31. The method of claim 30, wherein a duration a temperature above a limit temperature is used as a criterion.

32. The method of claim 30, wherein an absolute maximum temperature is used as a criterion.

33. The method of claim 30, wherein a maximum area above a temperature, or a maximum size of a melt pool, is used as a criterion.

34. A method for selectively solidifying a layer of an object by a laser or electron beam by a powder-based additive manufacturing process, the method comprising:
providing exposure vectors for the layer;
providing a model of the layer, wherein the model represents the layer and a portion of the object lying below the layer as a cross-section of the object, and takes into account a portion of the object lying below the layer as a location-dependent specific heat capacity and a location-dependent thermal resistance;
ascertaining a temperature curve by thermally simulating a scan of the layer with the exposure vectors using the model;
validating the temperature curve based on one or more criteria; and
scanning the layer by the laser or electron beam with the exposure vectors.
